(19) United States
(12) Patent Application Publication
(10) Pub. No.: US 2026/0277768 A1
(43) Pub. Date: Sep. 17, 2026

(54) PERFORMANCE OPTIMIZATION FOR A DATACENTER

(71) Applicant: NVIDIA CORPORATION, Santa Clara, CA (US)

(72) Inventors: Elad Mentovich, Tel Aviv (IL); Ryan Albright, Beaverton, OR (US); Siddha Ganju, San Jose, CA (US); Gal Ashkenazi, Santa Clara, CA (US); Jordan Levy, Portland, OR (US)

(21) Appl. No.: 19/079,854

(22) Filed: Mar. 14, 2025

(51) Int. Cl. G06F 11/34; B25J 9/16

(52) U.S. Cl. CPC G06F 11/3466; B25J 9/162; B25J 9/1679

(57) ABSTRACT

Embodiments provide for monitoring one or more datacenter performance metrics of a datacenter during a plurality of maintenance events, determining one or more actions using an artificial intelligence model to improve at least one datacenter performance metric, and initiating the one or more actions using a robotic mechanism at a defined location within the datacenter.

### BACKGROUND

Datacenters often include a plurality of server racks that host server trays of computing resources (e.g., graphical processing units (GPUs), central processing units (CPUs), data processing units (DPUs), and/or the like) and resource orchestrators. The connectivity of computing resources of a datacenter is typically configured according to design parameters for the computing resources, server trays, and/or server racks of the datacenter. However, the design parameters of a datacenter may change and/or the performance of the datacenter may degrade as maintenance issues arise during operation of the datacenter. Therefore, a need exists for solutions that determine optimal connectivity parameters for a datacenter over time (e.g., to mitigate potential maintenance issues) and for automatically making changes within the datacenter to implement updated optimal connectivity parameters.

### GENERAL DESCRIPTION

As artificial intelligence and/or machine learning use increases, the amount of information being processed by datacenters and communicated between large clusters of computing resources (e.g., graphical processing units (GPUs), central processing units (CPUs), data processing units (DPUs), and/or the like) is also increasing. The computing resources of datacenters are generally hosted by server trays mounted within server racks, and those computing resources are connected for communication within the datacenter, for example, for load balancing of processing tasks. The ability for these computing resources to communicate with one another is dependent in part of a connection topology within the datacenter, defining how the computing resources are connected to one another. That connection topology can be optimized for a particular datacenter (e.g., based at least in part on the number and type of computing resources in the datacenter), the maintenance status of the datacenter (e.g., based at least in part on certain computing resources being out of service), and/or the intended usage of the datacenter (e.g., model training and/or inference), and over time the optimal connection topology may change. However, implementing changes to the connection topology requires, in part, physically moving some connectors (e.g., optical fiber connectors) to new connection ports to redefine certain connections within the connection topology.

The communication topology of a datacenter is defined in terms of a plurality of L1 domains (e.g., individual servers) that are in communication with respective L2 domains or aggregation layers. For example, an L1 domain is a plurality of compute nodes, processing units, and/or compute elements that are either directly connected or via one layer of switches. An L2 domain is a domain where elements of the domain are connected through two layers of switches. For example, an L2 domain may aggregate traffic from a plurality of L1 domains to perform functions such as load balancing. Some datacenters may also include an L3 domain configured to route traffic between various L2 domains and communicate with networks external to the data center. An L1 domain may include one or more processing units, such as GPUs, CPUs, DPUs, PPUs, QPUs, and/or the like. These processing units are often housed on server trays that are mounted within server racks. Conventionally, a server rack may house a plurality of trays that each host a plurality of processing units (e.g., GPUs, CPUs, DPUs, PPUs, QPUs, and/or the like) and trays that host switches, such as a top-of-rack switch configured to communicate with the L2 domain (e.g., via switch fabric).

In at least one example embodiment, a datacenter comprises a plurality of network devices, such as network switches (e.g., Ethernet switches, IP routers, multiservice platforms, various transmission network elements, legacy communication equipment, or in any other suitable communication system) connected with a collection of servers or compute nodes comprising computing resources. A switch fabric defines the connection topology of the datacenter, and serves to transfer the data between the switch ports. A switch fabric comprises one or more interconnect circuits, which may be arranged in various switch fabric architectures, e.g., m*m crossbar, Banyan, Benes, Omega, Clos, multi-plane, synchronous transport signal (STS), time-slot interchange (TSI), shared memory, buffered crossbar, any other suitable blocking or non-blocking architecture, or any applicable mixed architecture thereof. A switch fabric is realized in typical embodiments by hardware, which may comprise Field Programmable Gate Arrays (FPGAs), Complex Programmable Logic Devices (CPLDs), application specific integrated circuits (ASICs), and/or bus interconnects. The datacenter may adhere to a networking topology (e.g., a hierarchal networking topology), such as a fat tree topology, a Slim Fly topology, a Dragonfly topology, and/or the like. The datacenter may route traffic amongst the network switches and servers therein, and at least one layer of the topology in the datacenter is coupled to the communication network to allow networking traffic to flow between the datacenter and the network device(s).

In order to mitigate maintenance issues during operation of a datacenter and/or to otherwise optimize connectivity within the datacenter over time, an artificial intelligence model may be utilized to monitor performance of the datacenter. In some embodiments, the artificial intelligence model may generate an optimal connectivity strategy for the datacenter based on performance data. For example, the optimal connectivity strategy may be determined based on performance parameters before and/or after maintenance issues are resolved and/or as the usage of the datacenter shifts (e.g., from model training to inference or vice versa). In some embodiments, maintenance operations and/or physical reconfiguration of cable connections within the datacenter may be performed by a robot that traverses an interior environment of the datacenter. A maintenance operation may include removal of debris in the interior environment of the datacenter, reconnection of cables for a server tray, reconnection of cables between server racks, and/or another type of maintenance operation with respect to the datacenter. In some embodiments, the robot may physically reconnect cables in response to a new connectivity topology being provided by the artificial intelligence model to provide optimized connectivity for computing resources of the datacenter.

According to an aspect of the present disclosure, a method for optimizing performance of a datacenter is provided. In an example embodiment, the method comprises monitoring one or more datacenter performance metrics of a datacenter during a plurality of maintenance events using an artificial intelligence model. In another example embodiment, the method additionally or alternatively comprises determining, using the artificial intelligence model, one or more actions to improve at least one datacenter performance metric. In another example embodiment, the method additionally or alternatively comprises initiating the one or more actions using a robotic mechanism at a defined location within the datacenter.

In some embodiments, initiating the one or more actions using a robotic mechanism comprises causing a mobile robot to move to the defined location within the datacenter. In some embodiments, initiating the one or more actions using a robotic mechanism comprises causing the robotic mechanism to perform the one or more actions with respect to an interior datacenter environment of the datacenter. In some embodiments, initiating the one or more actions using a robotic mechanism comprises causing the robotic mechanism to perform the one or more actions with respect to a server rack of the datacenter. In some embodiments, initiating the one or more actions using a robotic mechanism comprises causing the robotic mechanism to connect one or more cables at one or more server racks within the datacenter.

In some embodiments, monitoring the one or more datacenter performance metrics of the datacenter comprises capturing sensor data associated with an interior datacenter environment of the datacenter via a mobile robot. In some embodiments, monitoring the one or more datacenter performance metrics of the datacenter comprises capturing sensor data associated with a server rack of the datacenter via a mobile robot.

In some embodiments, the artificial intelligence model executes at least partially in the datacenter.

In some embodiments, the method further comprises monitoring the at least one datacenter performance metric subsequent to initiating the one or more actions using the robotic mechanism. In some embodiments, the method further comprises determining, using the artificial intelligence model, an action for the robotic mechanism to further improve the at least one datacenter performance metric.

According to another aspect of the present disclosure, a robotic system is provided. In an example embodiment, the robotic system comprises a mobile robot and one or more computing devices. In some embodiments, the mobile robot is configured to perform one or more robotic-based actions. In some embodiments, the one or more computing devices are configured to monitor one or more datacenter performance metrics of a datacenter during a plurality of maintenance events using an artificial intelligence model. In some embodiments, the one or more computing devices are configured to determine, using the artificial intelligence model, one or more actions to improve at least one datacenter performance metric. In some embodiments, the one or more computing devices are configured to initiate performance of the one or more actions using the mobile robot.

In some embodiments, the one or more computing devices are further configured to cause the mobile robot to move to the defined location within the datacenter. In some embodiments, the one or more computing devices are further configured to cause the mobile robot to perform the one or more actions with respect to an interior datacenter environment of the datacenter. In some embodiments, the one or more computing devices are further configured to cause the mobile robot to perform the one or more actions with respect to a server rack of the datacenter. In some embodiments, the one or more computing devices are further configured to cause the mobile robot to connect one or more cables at one or more server racks within the datacenter.

In some embodiments, the mobile robot is configured to capture sensor data associated with an interior datacenter environment of the datacenter during the plurality of maintenance events. In some embodiments, the mobile robot is configured to capture sensor data associated with a server rack of the datacenter during the plurality of maintenance events.

In some embodiments, the artificial intelligence model executes at least partially in the datacenter.

According to yet another aspect of the present disclosure, one or more non-transitory computer-readable storage media are provided. In an example embodiment, the one or more non-transitory computer-readable storage media store instructions that, when executed by one or more processors, cause the one or more processors to monitor one or more datacenter performance metrics of a datacenter during a plurality of maintenance events using an artificial intelligence model. In another example embodiment, the one or more non-transitory computer-readable storage media store instructions that, when executed by the one or more processors, cause the one or more processors to determine, using the artificial intelligence model, one or more actions to improve at least one datacenter performance metric. In another example embodiment, the one or more non-transitory computer-readable storage media store instructions that, when executed by the one or more processors, cause the one or more processors to initiate the one or more actions using a robotic mechanism at a defined location within the datacenter.

In some embodiments, the instructions further cause the one or more processors to cause a mobile robot to move to the defined location within the datacenter. In some embodiments, the instructions further cause the one or more processors to cause the robotic mechanism to perform the one or more actions with respect to a server rack of the datacenter.

### BRIEF DESCRIPTION OF THE SEVERAL VIEWS OF THE DRAWINGS

Reference will now be made to the accompanying drawings, which are not necessarily drawn to scale, and wherein:

FIG. 1 illustrates a block diagram of a system that can be specially configured within which one or more embodiments of the present disclosure may operate;

FIG. 2 illustrates a block diagram of an example apparatus that can be specially configured in accordance with one or more embodiments;

FIG. 3 illustrates a datacenter optimization system, in accordance with one or more embodiments.

FIG. 4 schematically illustrates an example server rack comprising a server tray, in accordance with one or more embodiments;

FIG. 5 is an external view of a server tray, in accordance with one or more embodiments;

FIG. 6 is a block diagram of an example system that may include one or more datacenters including server racks, in accordance with one or more embodiments;

FIG. 7 is a schematic diagram of an example datacenter that may include one or more optical interconnects, in accordance with one or more embodiments;

FIG. 8 is a block diagram that schematically illustrates a computing system that may include one or more trays mounted in one or more server racks of various embodiments;

FIG. 9 illustrates an example computing environment, in accordance with one or more embodiments;

FIG. 10 illustrates another example computer system that may include one or more trays mounted within one or more server racks, in accordance with one or more embodiments;

FIG. 11 illustrates an example datacenter, in accordance with one or more embodiments; and

FIG. 12 illustrates a process depicting example operations for providing performance optimization for a datacenter via a robotic system, in accordance with one or more embodiments.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

In datacenters, server trays hosting computing resources, switches, and/or the like tend to be mounted within server racks. Additionally, multiple server racks tend to be interconnected to provide a datacenter architecture that establishes connections between server trays and/or server racks. When a datacenter architecture within a datacenter is initially established, it is typically desirable to optimize the connectivity of computing resources, switches, server racks, and/or the like to provide the highest level of performance while ascribing to design parameters for the datacenter architecture. For example, the design parameters may consider an expected usage of the datacenter, such as primarily for training artificial intelligence models, for applying artificial intelligence models for inference, or the like. Over time however, those design parameters may change (e.g., as the expected usage changes) and/or the performance of the datacenter architecture may degrade as maintenance issues arise during operation of the datacenter architecture. Maintenance issues may arris due to foreign debris in a datacenter environment that impacts cooling of server trays (and consequently impacts the performance of computing resources), cooling systems of server trays that malfunction (e.g., liquid cooling systems that leak), cables that become detached from server trays, power supplies for server trays that fail, etc. Therefore, it is desirable to monitor a datacenter architecture over time such that maintenance and/or updates are provided to the initial datacenter architecture design. However, technical problems exist when monitoring a datacenter architecture. For example, manually performing maintenance and/or reconfiguring connections in a datacenter is inefficient and prone to errors. Additionally, forgoing maintenance and/or reconfiguration of connections in a datacenter may result in damage to components of the datacenter architecture. As an example, forgoing maintenance and/or reconfiguration of connections in a datacenter may result in data corruption and/or hardware damage for components of a server tray. Therefore, it is desirable mitigate potential maintenance issues for a datacenter and/or to mitigate potential issues during monitoring of a datacenter architecture.

Various embodiments provide technical solutions to these technical problems. In this regard, various embodiments provide performance optimization for a datacenter via an artificial intelligence model configured for determining an optimal connection topology and/or for implementing the optimal connection topology using a robotic system. The optimal connection topology may mitigate potential maintenance issues for the datacenter and/or to mitigate potential issues during monitoring of a datacenter architecture for the datacenter. Accordingly, a datacenter architecture may be provided with enhanced functionality in a datacenter environment to minimize data corruption and/or hardware damage for computing resources, server trays, server racks, and/or other components of a datacenter and/or to otherwise optimize performance of the datacenter based at least in part on an expected usage of the datacenter.

The robotic system may be capable of traversing an interior environment of the datacenter. For example, the robotic system may comprise one or more mobile robots that are configured to traverse an interior environment of the datacenter. The robotic system may also include one or more robotic mechanisms to enable actions to be performed with respect to the datacenter. For example, a robotic mechanism may include a robot arm, a robot gripper mechanism, a server tray removal tool, and/or another type of robotic mechanism to enable actions to be performed with respect to the datacenter. Additionally, the actions performed by the robotic system may be controlled based on an artificial intelligence (AI) model for optimizing the connection topology of the datacenter. For example, the AI model may be utilized to monitor performance of the datacenter architecture. The AI model may also generate an optimal connection topology for the datacenter architecture based on performance data captured during monitoring of the datacenter architecture.

Based on the performance data, maintenance operations and/or physical reconfiguration of cable connections within the datacenter may be performed by the robotic system. A maintenance operation may include removal of debris in the interior environment of the datacenter, disconnection and/or reconnection of cables for a server tray, reconnection of cables between server racks, and/or another type of maintenance operation with respect to the datacenter. The performance data may be captured before and/or after potential maintenance issues are resolved by the robotic system. For example, performance data may be captured before and/or after debris is removed from the datacenter environment by the robotic system. In another example, performance data may be captured before and/or after cables are reconnected to a server tray by the robotic system. In some embodiments, the robotic system may physically reconnect cables in response to a new connectivity suggestion being provided by the AI model to provide optimized connectivity for computing resources, server trays, server racks, and/or other components of the datacenter.

Thus, various embodiments provide a robotic system in combination with AI modeling to enable improved performance for a datacenter architecture and/or computing resources of a datacenter architecture by physically reconfiguring connections within the datacenter based at least in part on an updated connection topology determined by AI modeling. As a result, various embodiments provide automated configuration and/or reconfiguration of a datacenter to optimize the datacenter for efficiency, reliability, minimized system downtime, and/or improved performance. Various embodiments accordingly provide improvements to the fields of server trays, server racks, datacenters, datacenter architecture configurability, and/or the like.

### Processing System

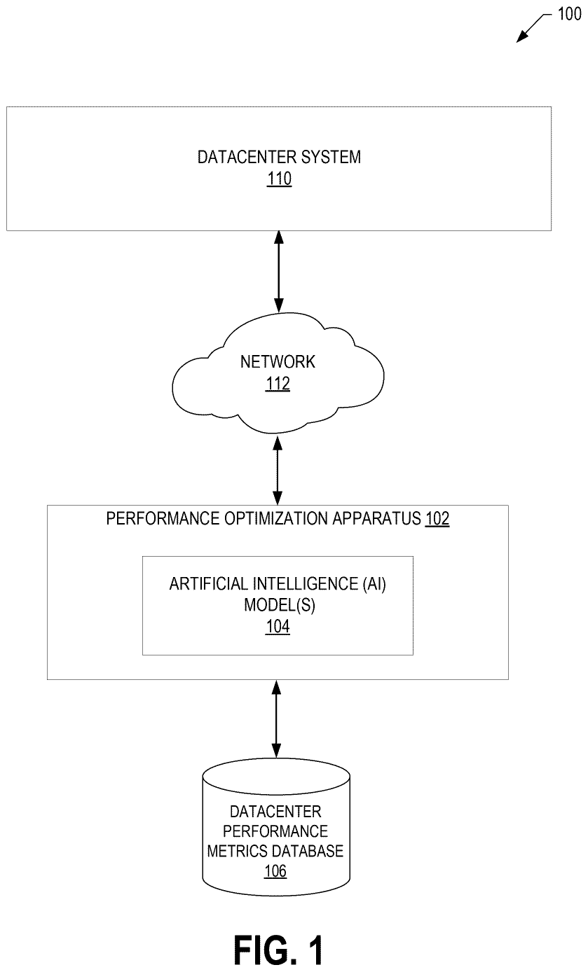

FIG. 1 illustrates a block diagram of a system that may be configured for embodiments of the present disclosure. Specifically, FIG. 1 illustrates an example processing system 100. The example processing system 100 includes a performance optimization apparatus 102, AI model(s) 104, a datacenter performance metrics database 106, and/or a datacenter system 110. In one or more embodiments, the processing system 100 includes at least one network 112 that enables transmission of data between one or more subsystem(s) and/or device(s) of the processing system 100.

The performance optimization apparatus 102 includes one or more computer(s) embodied in hardware, software, firmware, and/or a combination thereof. In some embodiments, the performance optimization apparatus 102 includes one or more application server(s), database server(s), computing terminal(s), and/or the like that are configured to perform the functionality described herein. In some embodiments, the performance optimization apparatus 102 embodies or includes a backend system (e.g., one or more server(s)) that are communicable over one or more network(s) (e.g., via the Internet or another communication system). Additionally or alternatively, in some embodiments, the performance optimization apparatus 102 includes one or more virtual computer(s) embodied in a software environment maintained via particular hardware, for example where the performance optimization apparatus 102 is maintained as a virtual environment on hardware of a central terminal supporting multiple software application(s). In some embodiments, the performance optimization apparatus 102 includes one or more hardware device(s) within the same physically defined space, such as a datacenter, a data warehouse, and/or the like. Alternatively or additionally, in some embodiments, the performance optimization apparatus 102 includes one or more hardware and/or software device(s) located remotely from one another and that communicate in conjunction with one another to provide the described functionality, for example embodied by one or more cloud computing system(s).

In some embodiments, the performance optimization apparatus 102 includes a plurality of sub-services that each support a portion of the functionality performed by the performance optimization apparatus 102. In some such embodiments, the plurality of sub-services may each be embodied by different hardware, software, firmware, and/or any combination thereof. Alternatively or additionally, in some embodiments, one or more of the sub-services share particular hardware, software, firmware, and/or any combination thereof. For example, in some embodiments, the performance optimization apparatus 102 may embody specially-configured software applications executed on shared hardware. In some embodiments, the performance optimization apparatus 102 may be executed via the datacenter system 110. For example, the performance optimization apparatus 102 may be locally-executed via the datacenter system 110.

In some embodiments, the datacenter system 110 embodies a datacenter and/or a datacenter architecture where data is communicated between clusters of computing resources (e.g., GPUs, CPUs, DPUs, and/or the like). The computing resources of the datacenter system 110 may be hosted by server trays mounted within server racks. In some embodiments, the datacenter system 110 includes a plurality of L1 domains (e.g., individual servers) that are in communication with respective L2 domains or aggregation layers. For example, an L1 domain is a plurality of compute nodes, processing units, and/or compute elements that are either directly connected or via one layer of switches. An L2 domain is a domain where elements of the domain are connected through two layers of switches. For example, an L2 domain may aggregate traffic from a plurality of L1 domains to perform functions such as load balancing. In some embodiments, the datacenter system 110 also include an L3 domain configured to route traffic between various L2 domains and communicate with networks external to the datacenter system 110. An L1 domain may include one or more processing units, such as GPUs, CPUs, DPUs, PPUs, QPUs, and/or the like. These processing units may be housed on server trays that are mounted within server racks. For example, a server rack of the datacenter system 110 may house a plurality of trays that each host a plurality of processing units (e.g., GPUs, CPUs, DPUs, PPUs, QPUs, and/or the like) and trays that host switches, such as a top-of-rack switch configured to communicate with the L2 domain (e.g., via switch fabric).

In some embodiments, the datacenter system 110 comprises a collection of network devices, such as network switches (e.g., Ethernet switches, IP routers, multiservice platforms, various transmission network elements, legacy communication equipment, or in any other suitable communication system) connected with a collection of servers or compute nodes. A switch fabric serves to transfer the data between the switch ports. A switch fabric comprises one or more interconnect circuits, which may be arranged in various switch fabric architectures, e.g., m*m crossbar, Banyan, Benes, Omega, Clos, multi-plane, synchronous transport signal (STS), time-slot interchange (TSI), shared memory, buffered crossbar, any other suitable blocking or non-blocking architecture, or any applicable mixed architecture thereof. A switch fabric is realized in typical embodiments by hardware, which may comprise Field Programmable Gate Arrays (FPGAs), Complex Programmable Logic Devices (CPLDs), application specific integrated circuits (ASICs), and/or bus interconnects. A datacenter architecture of the datacenter system 110 may adhere to a networking topology (e.g., a hierarchal networking topology), such as a fat tree topology, a Slim Fly topology, a Dragonfly topology, and/or the like. In some embodiments, the datacenter system 110 may route data traffic amongst the network switches and servers therein, and at least one layer of the topology in the datacenter system 110 may be coupled to the communication network to allow networking data traffic to flow between the datacenter system 110 and the network device(s). In some embodiments, the datacenter system 110 may be a high-performance computing infrastructure that provides optimized computing clusters of GPUs, CPUs, DPUs, and/or the like for artificial intelligence, machine learning, and/or other computing tasks via a series of server racks comprising server trays.

In some embodiments, the performance optimization apparatus 102 supports an AI platform for providing performance optimization for the datacenter system 110 and/or a controlling a robotic system associated with the datacenter system 110. In some embodiments, the performance optimization apparatus 102 utilizes datacenter performance metrics stored in the datacenter performance metrics database 106 to provide the performance optimization for the datacenter system 110 and/or to control the robotic system associated with the datacenter system 110. For example, the datacenter performance metrics stored in the datacenter performance metrics database 106 may be obtained by monitoring the datacenter system 110. In some embodiments, monitoring of the datacenter system 110 may occur during and/or in connection with one or more maintenance events associated with the datacenter system 110. In some embodiments, a maintenance event may be associated with inspection of the datacenter system 110 by a robotic system. In some embodiments, a maintenance event may be associated with a change in usage and/or configuration of the datacenter system 110 with respect to a training stage and an inference stage for the AI model(s) 104. For example, the performance optimization apparatus 102 may provide the performance optimization for the datacenter system 110 in response to a determination that a certain change has occurred in the datacenter performance metric(s) 310 with respect to a previous training stage and a current inference stage for the AI model(s) 104. In some embodiments, the performance optimization apparatus 102 additionally or alternatively provides one or more functionalities associated with the datacenter system 110.

In some embodiments, the AI model(s) 104 may be a data construct that describes parameters, hyperparameters, and/or defined operations configured to determine one or more actions with respect to the datacenter system 110 and/or a robotic system associated with the datacenter system 110 to improve at least one datacenter performance metric associated with the datacenter system 110. For example, the AI model(s) 104 may include one or more layers, one or more rule-based layers, one or more neural network layers, and/or one or more other types of layers that depend on trained parameters, coefficients, and/or the like. The AI model(s) 104 may include any type of AI model configured, trained, and/or the like to determine the one or more actions with respect to the datacenter system 110 and/or a robotic system associated with the datacenter system 110. In some embodiments, the AI model(s) 104 may provide robotic system training data to train the robotic system to perform the one or more actions. For example, the robotic system training data may include a set of steps and/or workflows to be performed by the robotic system to enable one or more tasks within the datacenter system 110. Additionally, the AI model(s) 104 may include one or more of any type of artificial intelligence model including one or more supervised, unsupervised, semi-supervised, reinforcement learning models, and/or the like. For instance, the AI model(s) 104 may include a supervised model that may be trained using a historical training dataset. In some examples, the AI model(s) 104 may include multiple models configured to perform one or more different stages of a datacenter performance optimization process. In various embodiments, the AI model(s) 104 may be configured as a machine learning model, a neural network model, a deep learning model, a convolutional neural network (CNN) model, a generative model, a transformer model, and/or another type of AI model. In some embodiments, an AI platform may include the performance optimization apparatus 102 and the AI model(s) 104. For example, the AI model(s) 104 may be a first party model for the performance optimization apparatus 102. In some embodiments, the AI model(s) 104 may be a third-party model that is communicatively coupled to the performance optimization apparatus 102 via the network 112. In some embodiments, the performance optimization apparatus 102 and/or the AI model(s) 104 may be executed at least partially in the datacenter system 110.

In some embodiments, the AI model(s) 104 is trained and/or retrained based at least in part on a datacenter architecture of the datacenter system 110. For example, the AI model(s) 104 may be trained and/or retrained based connectivity for computing resources, server trays, server racks, and/or other components of the datacenter system 110. Training the AI model(s) 104 may include modifying and/or optimizing parameters, hyperparameters, coefficients, weights, biases, defined operations, and/or the like for the AI model(s) 104. In some embodiments, the AI model(s) 104 may be trained using a training dataset that is specially configured for the datacenter system 110. For example, a training dataset for the AI model(s) 104 may correspond to data and/or features associated with the datacenter system 110. Alternatively, in some embodiments, the AI model(s) 104 may be trained using a training dataset associated with two or more datacenter system domains. For example, a training dataset for the AI model(s) 104 may correspond to data and/or features associated with two or more datacenter systems. In some embodiments, a training dataset for the AI model(s) 104 may correspond to data without a specific association to a particular datacenter system.

In some embodiments, the AI model(s) 104 may be repeatedly trained via two or more training stages until performance criteria for the data architecture of the datacenter system 110 are satisfied. For example, the AI model(s) 104 may be repeatedly trained via two or more training stages until performance criteria associated with connectivity for computing resources, server trays, server racks, and/or other components of the datacenter system 110 are satisfied. The performance criteria may be determined manually based on user input related to configuration of computing resources, server trays, server racks, and/or other components of the datacenter system 110. Alternatively, the performance criteria may be determined dynamically by the performance optimization apparatus 102 based on a real-time execution of the datacenter system 110. For example, at least a portion of datacenter performance metrics provided via the real-time execution of the datacenter system 110 may be utilized to determine characteristics of the datacenter system 110. Additionally, the characteristics of the datacenter system 110 may be utilized to determine the performance criteria specifically configured for the datacenter system 110.

In some embodiments, the datacenter system 110 may collect and/or log historical performance data based on real-time execution of the datacenter system 110. In some embodiments, the historical performance data may be aggregated based on metrics associated with multiple computing resources, server trays, server racks, and/or other components of the datacenter system 110. For example, the historical performance data may be aggregated based on connectivity insights associated with multiple computing resources, server trays, server racks, and/or other components of the datacenter system 110. Additionally or alternatively, the historical performance data may be component-specific data associated with a particular computing resource, server tray, server rack, and/or other particular component of the datacenter system 110. For example, the historical performance data may provide connectivity insights for a particular computing resource, server tray, server rack, and/or other particular component of the datacenter system 110.

In some embodiments, the AI model(s) 104 may be repeatedly trained via two or more training stages based on the historical performance data. For example, by being trained based on the historical performance data via two or more training stages, the AI model(s) 104 may be trained to identify certain types of malfunctions, faults, maintenance events, and/or other issues associated with the datacenter system 110. In some embodiments, parameters, hyperparameters, coefficients, weights, biases, defined operations, and/or the like for the AI model(s) 104 may be updated and/or optimized based on the historical performance data.

In some embodiments, the performance optimization apparatus 102 supports automatically receiving data transmissions from the datacenter system 110 based on monitoring of the datacenter system 110. Additionally or alternatively, in some embodiments, the performance optimization apparatus 102 supports providing data via digital mechanism(s) (e.g., control signals for a robotic system, graphical user interfaces, customized dashboards, widgets, electronic portals, electronic communication channels, and/or the like).

The network 112 may be a communications network and/or may be configurable to be embodied in any of a myriad of network configurations. In some embodiments, the network 112 embodies a public network (e.g., the Internet). In some embodiments, the network 112 embodies a private network (e.g., an internal, localized, or closed-off network between particular devices). In some other embodiments, the network 112 embodies a hybrid network (e.g., a network enabling internal communication between particular connected devices and external communication with other devices). The network 112 in some embodiments includes one or more base station(s), relay(s), router(s), switch(es), cell tower(s), communications cable(s) and/or associated routing station(s), and/or the like. In some embodiments, the network 112 includes one or more computing device(s) controlled by individual entities (e.g., an entity-owner router and/or modem) and/or one or more external utility devices (e.g., Internet service provider communication tower(s) and/or other device(s)).

The computing devices of the processing system 100 may each communicate in whole or in part over a portion of one or more communication network(s), such as the network 112. For example, each of the components of the processing system 100 may be communicatively coupled to transmit data to and/or receive data from one another over the same and/or different wireless or wired networks embodying the network 112. Non-limiting examples of network configuration(s) for the network 112 include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network(s), the various embodiments are not limited to this particular architecture. In other embodiments, one or more computing entities share one or more components, hardware, and/or the like, or otherwise are embodied by a single computing device such that connection(s) between the computing entities are altered and/or rendered unnecessary. Alternatively or additionally still, in some embodiments the network 112 enables communication to one or more other computing device(s) not depicted, for example client device(s) for accessing functionality of any of the subsystems therein via native and/or web-based application(s), and/or the like.

### Performance Optimization Apparatus

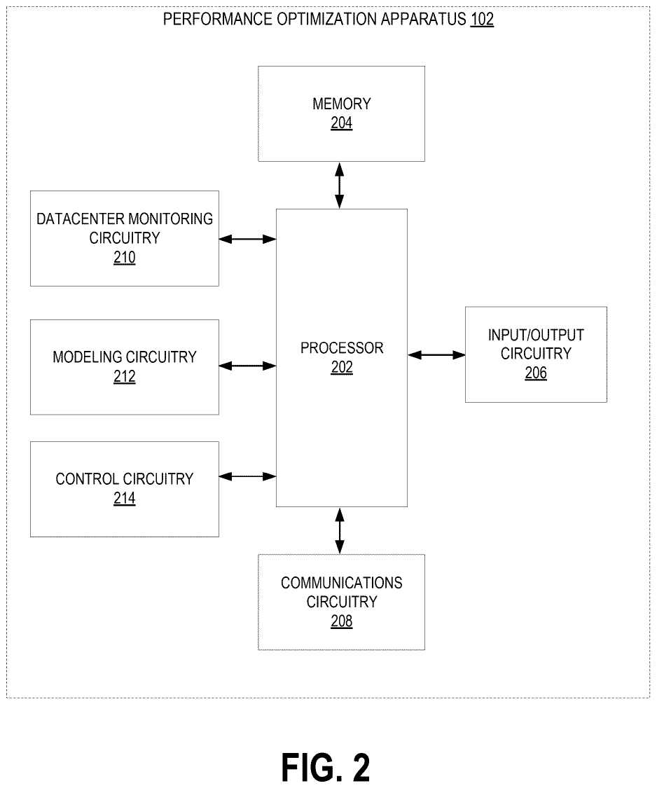

FIG. 2 illustrates a block diagram of an example apparatus that can be specially configured in accordance with at least one example embodiment of the present disclosure. Specifically, FIG. 2 illustrates the performance optimization apparatus 102 in accordance with at least one example embodiment of the present disclosure. The performance optimization apparatus 102 includes processor 202, memory 204, input/output circuitry 206, communications circuitry 208, datacenter monitoring circuitry 210, modeling circuitry 212, and/or control circuitry 214. In some embodiments, the performance optimization apparatus 102 is configured, using one or more of the sets of circuitry 206, 208, 210, 212, and/or 214, to execute and perform one or more of the operations described herein. In some embodiments, the performance optimization apparatus 102 may be embodied as one or more computing resources within the datacenter system 110.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the performance optimization apparatus 102 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the performance optimization apparatus 102 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the performance optimization apparatus 102. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the performance optimization apparatus 102 to carry out various functions in accordance with example embodiments of the present disclosure.

The processor 202 can be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the performance optimization apparatus 102, and/or one or more remote or “cloud” processor(s) external to the performance optimization apparatus 102.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. In some embodiments, the processor 202 includes or is embodied by a CPU, microprocessor, and/or the like that executes computer-coded instructions, for example stored via the non-transitory memory 204.

In some embodiments, the performance optimization apparatus 102 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as an electronic interface, a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor can be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user. In some embodiments, the input/output circuitry 206 includes hardware, software, firmware, and/or a combination thereof, that facilitates simultaneously display of particular data via a plurality of different devices.

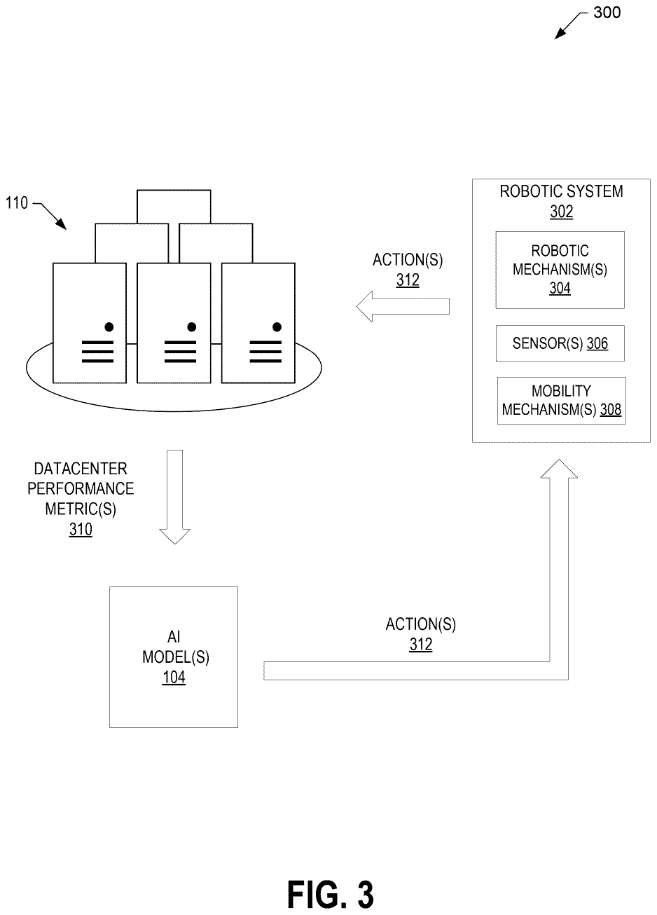

In some embodiments, the performance optimization apparatus 102 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the performance optimization apparatus 102. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device, capture device, and/or other external computing device in communication with the performance optimization apparatus 102. In some embodiments, the communications circuitry 208 enables transmission to and/or receipt of data from a robotic system (e.g., the robotic system 302 of FIG. 3) in communication with the performance optimization apparatus 102.

In some embodiments, the performance optimization apparatus 102 includes the datacenter monitoring circuitry 210. The datacenter monitoring circuitry 210 includes hardware, software, firmware, and/or a combination thereof, that supports various functionality associated with monitoring the datacenter system 110. For example, in some embodiments, the datacenter monitoring circuitry 210 includes hardware, software, firmware, and/or a combination thereof, that monitors one or more datacenter performance metrics of the datacenter system 110.

Additionally or alternatively, in some embodiments, the datacenter monitoring circuitry 210 includes hardware, software, firmware, and/or a combination thereof, that enables access to one or more API(s), FTP connection(s), and/or the like to securely acquire, receive, retrieve, and/or otherwise identify entity data from one or more system(s) external from the performance optimization apparatus 102 such as, for example, the datacenter system 110 and/or the datacenter performance metrics database 106. In some embodiments, the datacenter monitoring circuitry 210 includes a separate processor, specially configured field programmable gate array (FPGA), or a specially programmed application specific integrated circuit (ASIC).

In some embodiments, the performance optimization apparatus 102 includes the modeling circuitry 212. The modeling circuitry 212 includes hardware, software, firmware, and/or a combination thereof, that supports various functionality associated with the AI model(s) 104. For example, in some embodiments, the modeling circuitry 212 includes hardware, software, firmware, and/or a combination thereof, that determines, using the one or more AI models, one or more actions associated with the robotic system to improve at least one datacenter performance metric associated with the datacenter system 110. In some embodiments, the modeling circuitry 212 includes a separate processor, specially configured FPGA, or a specially programmed ASIC.

In some embodiments, the performance optimization apparatus 102 includes the control circuitry 214. The control circuitry 214 includes hardware, software, firmware, and/or a combination thereof, that supports various functionality associated with a robotic system associated with the datacenter system 110. For example, in some embodiments, the control circuitry 214 includes hardware, software, firmware, and/or a combination thereof, that initiates the one or more actions using a robotic mechanism of the robotic system at a defined location within the datacenter system 110. In some embodiments, the control circuitry 214 initiates the one or more actions by generating one or more instruction signals (e.g., one or more control signals) for the robotic system and/or the robotic mechanism of the robotic system. In some embodiments, the control circuitry 214 initiates the one or more actions based on feedback (e.g., sensor data and/or acknowledgment signals) received from the robotic system in response to an action or a set of actions being performed by the robotic mechanism. In some embodiments, the control circuitry 214 includes a separate processor, specially configured FPGA, or a specially programmed ASIC. In some embodiments, the communications circuitry 208 includes hardware, software, firmware, and/or a combination thereof, that transmits one or more control signals to the robotic system to initiate the one or more actions with respect to the datacenter system 110.

Additionally or alternatively, in some embodiments, two or more of the sets of circuitries 202-214 are combinable. Alternatively or additionally, in some embodiments, one or more of the sets of circuitry perform some or all of the functionality described associated with another component. For example, in some embodiments, two or more of the sets of circuitry 206-214 are combined into a single module embodied in hardware, software, firmware, and/or a combination thereof. Similarly, in some embodiments, one or more of the sets of circuitry, for example the datacenter monitoring circuitry 210, modeling circuitry 212, and/or control circuitry 214, is/are combined with the processor 202, such that the processor 202 performs one or more of the operations described above with respect to each of these sets of circuitry 210-214. In some embodiments, one or more of circuitries 202-214 may be executable via the datacenter system 110. For example, one or more of circuitries 202-214 may be executable via one or more computing resources, server trays, server racks, and/or other components of the datacenter system 110.

### Datacenter Optimization System

FIG. 3 illustrates a datacenter optimization system 300 in accordance with one or more embodiments of the present disclosure. The datacenter optimization system 300 includes the datacenter system 110, the one or AI models 104, and a robotic system 302. In various embodiments, the datacenter system 110 includes a plurality of server racks where each server rack is configured to have one or more trays mounted therein. For example, a server tray may include one or more processing units, switches, and/or other processing components. The various server trays of a server rack may be in communication with one another according to a topology of the datacenter via cable cartridges. In some embodiments, various server racks may be in communication with one another via optical interconnects, in accordance with a topology of the datacenter. In various embodiments, a server rack includes one more server trays that are air cooled (e.g., include integrated fans) and/or one or more server trays that are liquid cooled (e.g., are fluidly coupled to a liquid cooling manifold of the server rack). In some embodiments, a server rack may include a first L1 domain comprising one or more trays that are air cooled and a second L1 domain comprising one or more trays that are liquid cooled.

The robotic system 302 may comprise one or more mobile robots that are configured to traverse an interior environment of the datacenter system 110. The robotic system 302 may also include robotic mechanism(s) 304, sensor(s) 306, and/or mobility mechanism(s) 308. The robotic mechanism(s) 304 may enable action(s) 312 to be performed with respect to the datacenter system 110. For example, the robotic mechanism(s) 304 may include a robot arm, a robot gripper mechanism, a server tray removal tool, and/or another type of robotic mechanism to enable the action(s) 312 to be performed with respect to the datacenter system 110. The action(s) 312 performed by the robotic system 302 may be controlled based on the AI model(s) 104. For example, the AI model(s) 104 may be utilized to monitor datacenter performance metric(s) 310 of the datacenter system 110. In some embodiments, the AI model(s) 104 may compare the datacenter performance metric(s) 310 to performance criteria for the datacenter system 110. Additionally, the AI model(s) 104 may determine the more action(s) 312 to improve at least one datacenter performance metric for the datacenter system 110. For example, the AI model(s) 104 may determine the more action(s) 312 to fix one or more faults associated with the datacenter system 110, fix one or more maintenance issues associated with the datacenter system 110, and/or reoptimize connectivity of the datacenter system 110 based on the comparison of the datacenter performance metric(s) 310 to the performance criteria for the datacenter system 110. In an example, the action(s) 312 may correspond to one or actions for removing debris from the datacenter system 110 by blowing compressed air and/or picking up the debris via the robotic mechanism(s) 304 (e.g., a compressed air nozzle, a vacuum nozzle, an articulating grabber, and/or the like). In another example, the action(s) 312 may correspond to one or actions for disconnecting a cable from a first port of a server tray and connecting the cable to a second port the server tray via the robotic mechanism(s) 304 (e.g., using a robotic mechanism 304 such as an articulating grabber or other mechanism specifically configured for removing cable connectors). In another example, the action(s) 312 may correspond to one or actions for disconnecting a cable from a first port of a server tray and connecting the cable to a second port of a second server tray via the robotic mechanism(s) 304. In another example, the action(s) 312 may correspond to reorganizing connections for a set of cable connectors on a front panel of a server tray. In another example, the action(s) 312 may correspond to reorganizing server trays on a server rack (e.g., using a robotic mechanism specifically configured for removing server trays from server racks).

In some embodiments, the datacenter performance metric(s) 310 includes information associated with network resource utilization patterns for the datacenter system 110, power consumption metrics for the datacenter system 110, thermal profiles for the datacenter system 110, network traffic patterns for the datacenter system 110, workload characteristics for the datacenter system 110, sensor data captured by the sensor(s) 306 of the robotic system 302, and/or other datacenter performance metrics. In some embodiments, at least a portion of the datacenter performance metric(s) 310 may be stored in the datacenter performance metrics database 106. In some embodiments, at least a portion of the datacenter performance metric(s) 310 may be stored by the memory 204 of the performance optimization apparatus 102. In some embodiments, the performance optimization apparatus 102 may generate a feature set for the AI model(s) 104 based on the datacenter performance metric(s) 310. For example, the feature set may be extracted from the datacenter performance metric(s) 310. The feature set may include one or more features, data items, data elements, or data fields associated with the datacenter performance metric(s) 310. In some embodiments, the performance optimization apparatus 102 may perform one or more data processing techniques to generate the feature set. By way of example, the one or more data processing techniques may include or otherwise be associated with data cleansing, structured metadata extraction, data normalization, thread delineation, noise reduction, and/or the like. Additionally, the feature set may be provided as input to the AI model(s) 104. In some embodiments, the AI model(s) 104 may be applied to the feature set to determine the more action(s) 312.

The sensor(s) 306 may enable inspection of one or more components and/or one or more areas of the datacenter system 110 for a potential maintenance issue. For example, the sensor(s) 306 may include camera sensor(s), video sensor(s), infrared capture device(s), Light Detection and Ranging (LiDAR) sensor(s), and/or other sensor(s) capable of capturing sensor data associated with an interior datacenter environment of the datacenter system 110. In some embodiments, the robotic system 302 may pass real-time generated sensor data generated by the sensors 306 to the control circuitry 214 to enable the control circuitry 214 to determine actions and/or movements for one or more robots of the robotic system 302. This connection may define a feedback loop, as the robot performs recommended actions, the robotic system 302 sends newly generated sensor data, enabling the control circuitry 214 to determine refined/updated actions to be performed by the robotic. In this way, the robot may move one or more robotic mechanisms 304 with sufficient spatial precision to pick up and/or manipulate objects using the robotic mechanisms 304, such as connectors for connection with one or more ports. The mobility mechanism(s) 308 may enable traversal of the robotic system 302 within an interior datacenter environment of the datacenter system 110. For example, the mobility mechanism(s) 308 may include a wheeled mobility mechanisms associated with two or more wheels, a tracked mobility mechanism associated with continuous tracks, a legged mobility mechanism associated with two or more robotic legs, a drone mobility mechanism associated with flight capabilities, or another type of mobility mechanism to enable traversal of the robotic system 302 within an interior datacenter environment of the datacenter system 110.

In some embodiments, the robotic system 302 may dock at a designated location within an interior datacenter environment of the datacenter system 110. When the datacenter system 110 is deemed to be adequately utilized for one or more artificial intelligence, machine learning, and/or other computing tasks, the performance optimization apparatus 102 may transmit a control signal to the robotic system 302 to traverse the interior environment of the datacenter system 110 to identify potential maintenance events associated with the datacenter system 110. In some embodiments, at least a portion of the datacenter performance metric(s) 310 may be generated during one or more maintenance events associated with the datacenter system 110. In some embodiments, a maintenance event may be associated with inspection of an interior datacenter environment and/or components of the datacenter system 110 by the robotic system 302. In some embodiments, the robotic system 302 may navigate the interior datacenter environment of the datacenter system 110 by scanning digital codes (e.g., quick-response (QR) codes), visual tags associated with a visual fiducial system, and/or other visual indicators within the interior datacenter environment of the datacenter system 110. The digital codes, visual tags, and/or other visual indicators may be respectively appended to server racks, server trays, and/or other designated locations throughout the interior datacenter environment of the datacenter system 110.

In response to the robotic system 302 successfully traversing a defined location indicated by the control signal, the robotic system 302 may inspect one or more components and/or one or more areas of the datacenter system 110 for a potential maintenance issue using sensor(s) 306. For example, the robotic system 302 may determine whether a leak from a cooling system of a server tray is present in the datacenter system 110 by scanning for fluid on the floor of the interior datacenter environment of the datacenter system 110 via a camera sensor and/or a video sensor. In another example, the robotic system 302 may determine whether foreign debris (e.g., paper, plastic wrappers, and/or other lightweight objects) are present in the datacenter system 110 by scanning for the foreign debris on the floor of the interior datacenter environment of the datacenter system 110 via a camera sensor, a video sensor, an infrared capture device, and/or a LiDAR sensor. The foreign debris may be capable of being blown by air currents in the interior datacenter environment and potentially pulled into a fan intake of a server tray, thereby blocking airflow and/or reducing cooling efficiency of the server tray. In yet another example, the robotic system 302 may inspect cables connected to equipment (e.g., server trays and/or server racks) at the defined location to ensuring that all necessary cables are properly plugged into the equipment via a camera sensor, a video sensor, and/or a LiDAR sensor. In a non-limiting example, the robotic system 302 may determine whether respective power cables and/or Ethernet cables are properly connected to a server tray via a camera sensor, a video sensor, and/or a LiDAR sensor.

In yet another example, the robotic system 302 may analyze status light-emitting diodes (LEDs) such as LED panel mount indicators of a server tray, a server rack, a power supply unit, and/or other equipment at the defined location via a camera sensor, a video sensor, an infrared capture device, and/or a LiDAR sensor. For instance, the robotic system 302 may determine whether the status LEDs correspond to a first visual indicator (e.g., a solid green LED light) corresponding to normal operation of an equipment or a second visual indictor (e.g., a flashing green light or a red light) corresponding to an issue with the equipment. In yet another example, the robotic system 302 may verify a location and/or presence of equipment (e.g., server trays) within a server rack via a camera sensor, a video sensor, an infrared capture device, and/or a LiDAR sensor. For instance, the robotic system 302 may determine whether equipment mounted within a server rack has been moved, whether a previously server rack is now empty, whether new equipment has been added to a server rack, etc. In some embodiments, after completing the inspection at the defined location indicated by the control signal, the robotic system 302 may return to the designated docking location within the interior datacenter environment of the datacenter system 110. In some embodiments, after completing the inspection at the defined location indicated by the control signal, the robotic system 302 may travers to a new defined location indicated by the control signal or a new control signal.

In some embodiments, at least a portion of the datacenter performance metric(s) 310 may be generated by the robotic system 302 based on one or more inspections performed by the robotic system 302. In some embodiments, the performance optimization apparatus 102 may generate a digital twin of the datacenter system 110 based on data generated by the robotic system 302 via one or more inspections performed by the robotic system 302. For example, the performance optimization apparatus 102 may generate an omniverse representation of the interior datacenter environment of the datacenter system 110 based on data generated by the robotic system 302 via one or more inspections performed by the robotic system 302. In some embodiments, the digital twin may be stored in the datacenter performance metrics database 106. In some embodiments, the digital twin may be stored in the memory 204 of the performance optimization apparatus 102. In some embodiments, data generated by the robotic system 302 via one or more inspections performed by the robotic system 302 may be utilized to train or retrain the AI model(s) 104. In some embodiments, the robotic system 302 may return to the defined location indicated by the control signal after a defined interval of time to reinspect one or more components and/or one or more areas of the datacenter system 110 for a potential maintenance issue. For example, the robotic system 302 may return to the defined location indicated by the control signal after a defined interval of time to determine whether a portion of the datacenter system 110 associated with the defined location is working properly. Additionally, at least a portion of the datacenter performance metric(s) 310 may be generated by the robotic system 302 based on the reinspection of one or more components and/or one or more areas of the datacenter system 110.

### Example Datacenter Systems

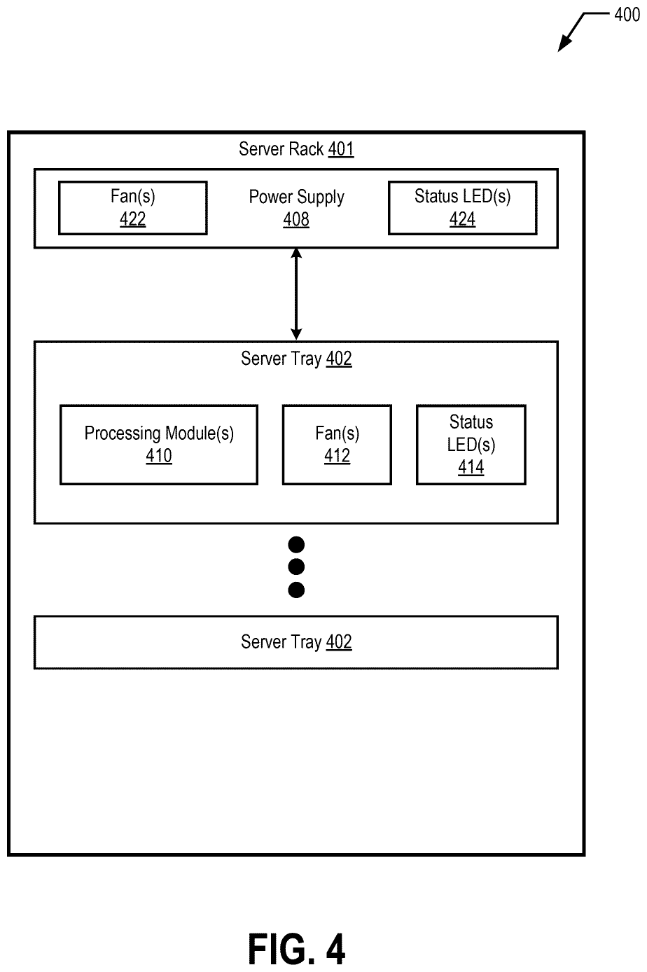

FIG. 4 illustrates a datacenter processing system 400 comprising a server rack 401 in accordance with one or more embodiments of the present disclosure. The datacenter processing system 400 may be one of a plurality of datacenter processing systems 400 within the datacenter system 110. The server rack 401 includes server tray(s) 402 and a power supply 408. The server rack 401 may transmit power from the power supply 408 of the server rack 401 to respective server trays of the server rack 401. For example, the server rack 401 may transmit power from the power supply 408 to the server tray(s) 402, as discussed further herein. The server tray(s) 402 includes processing module(s) 410. For example, the processing module(s) 410 may be or include one or more of processing circuitry, an Integrated Circuit (IC) chip, a microprocessor, a CPU, a GPU, a DPU, a Field Programmable Gate Array (FPGA), a network interface controller (NIC), an application specific integrated circuit (ASIC), combinations thereof, and the like. In some embodiments, the server tray(s) 402 include fan(s) 412 and/or status LED(s) 414. The fan(s) 412 may be integrated fan(s) that are configured to air cool the server tray(s) 402 and/or the processing module(s) 410. The status LED(s) 414 may provide a visual indication regarding a functionality status of the server tray(s) 402 and/or the processing module(s) 410. In some embodiments, the server tray(s) 402 provides a structure for housing circuitry components of the server tray(s) 402 such as the processing module(s) 410. In some embodiments, the power supply 408 includes fan(s) 422 and/or status LED(s) 424. The fan(s) 422 may be integrated fan(s) that are configured to air cool the power supply 408. The status LED(s) 424 may provide a visual indication regarding a functionality status of the power supply 408. In some embodiments, the power supply 408 is a modular power supply unit of the server rack 401.

The server rack 401 may be located within the datacenter system 110. For example, the datacenter may include the server rack 401 and one or more other server racks comprising respective pluralities of server trays mounted therein. A server tray such as the server tray(s) 402 may include various components that communicate with one another via a fast and robust communication infrastructure. For example, optical interconnects may enable communication between various server trays and/or server racks. In some embodiments, the datacenter may comprise a collection of network devices, such as network switches (e.g., Ethernet switches, IP routers, multiservice platforms, various transmission network elements, legacy communication equipment, or in any other suitable communication system) connected with a collection of servers or compute nodes. A switch fabric serves to transfer the data between the switch ports. A switch fabric comprises one or more interconnect circuits, which may be arranged in various switch fabric architectures, e.g., m*m crossbar, Banyan, Benes, Omega, Clos, multi-plane, STS, TSI, shared memory, buffered crossbar, any other suitable blocking or non-blocking architecture, or any applicable mixed architecture thereof. A switch fabric is realized in typical embodiments by hardware, which may comprise FPGAs, CPLDs, ASICs, and/or bus interconnects. The datacenter may adhere to a networking topology (e.g., a hierarchal networking topology), such as a fat tree topology, a Slim Fly topology, a Dragonfly topology, and/or the like. The datacenter may route traffic amongst the network switches and servers therein, and at least one layer of the topology in the datacenter is coupled to the communication network to allow networking traffic to flow between the datacenter and the network device(s).

In some embodiments, optical interconnects include transceivers used to connect network-connected devices (e.g., remote client switches, network adapters such as Network Interface controllers (NICs) and Host Channel Adapters (HCAs), Smart-NICs (NICs comprising embedded CPUs), network-enabled GPUs, and the like). The terms “network-connected device” and “network device” are used interchangeably herein. In certain embodiments, an optical interconnect includes a substrate, one or more optical waveguides, one or more first micro-lenses, one or more second micro-lenses, and first and second mechanical fixtures.

A “node” as described herein may refer to a network switch to which a plurality of CPUs, GPUs, DPUs, or memory media are connected in an arbitrary number. The network switch may communicate with other network switches of the same kind to which the same processor and memory units may be connected. However, in other implementations, “node” may also refer to a processor which may be responsible for communication with all other nodes in the network or subnetwork.

An “optical fiber” as described herein may refer to a single optical fiber (e.g., including a core and a cladding) to provide unidirectional optical communication, may refer to a bidirectional pair of optical fibers (e.g., each including a core and a cladding) to provide both transmit and receive communications in an optical network, or may refer to a multi-core fiber, such that a single cladding could encapsulate a plurality of single-mode cores. Optical fibers may extend contiguously and uninterrupted between node or send/receive pairs (e.g., via pass-through connections) or include two or more fibers connected via fiber-to-fiber connections such that the fibers function or perform as a single fiber.

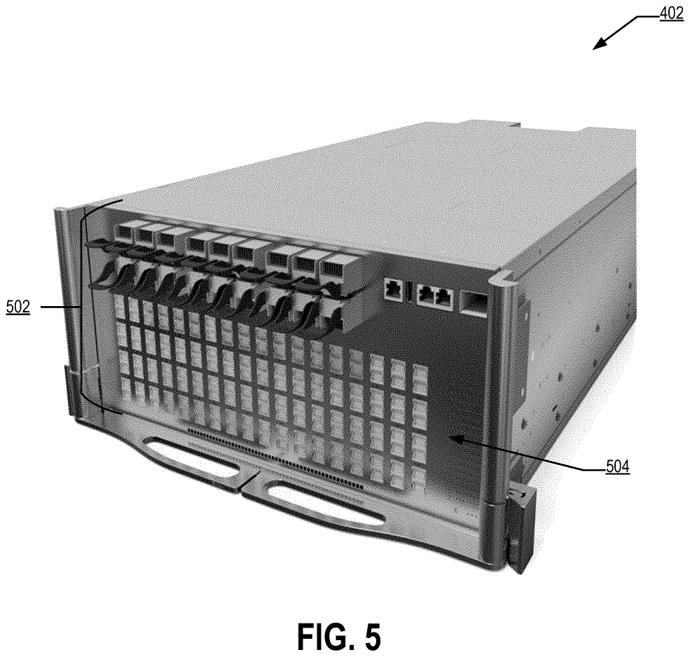

In various embodiments, the server rack 401 may be configured to receive and/or accommodate a variety of server trays including the server tray(s) 402. For example, the server rack 401 may accommodate a server tray(s) 402 embodied as shown in FIG. 5, which is an optical switch tray configured to optically connect a plurality of compute trays each having one or more processing resources. The server rack 401 may additionally accommodate the server tray(s) 402 embodied as compute trays. Although FIG. 5 specifically illustrates a switch tray, it should be understood that the features and components discussed herein may be embodied as components of a compute tray. In certain embodiments, the server rack 401 includes a chassis and rails that are in accordance with the Electronic Industries Alliance (EIA) standards. The server rack may also include a cable cartridge in accordance with EIA standards and/or a busbar that is Open Rack Version 3 (ORV3) standards compliant.

In some embodiments, the datacenter performance metric(s) 310 includes information associated with network resource utilization patterns for the processing module(s) 410, power consumption metrics for the power supply 408, thermal profiles for the processing module(s) 410, network traffic patterns for the server tray(s) 402, workload characteristics for the processing module(s) 410, sensor data associated with the server rack 401, sensor data associated with the server trays(s), information associated with the status LED(s) 414, information associated with the status LED(s) 424, and/or other datacenter performance metrics associated with the server rack 401. Additionally, at least a portion of the datacenter performance metric(s) 310 may be generated during one or more maintenance events associated with the server rack 401. In some embodiments, a maintenance event may be associated with inspection of the server rack 401 by the robotic system 302. To optimize performance of the server rack 401, the server tray(s) 402, and/or the power supply 408, the AI model(s) 104 may determine the action(s) 312 to be performed by the robotic system 302. For example, the robotic mechanism(s) 304 may perform the action(s) 312 with respect to the server rack 401, the server tray(s) 402, and/or the power supply 408. In some embodiments, the robotic mechanism(s) 304 may perform the action(s) 312 with respect to the fans(s) 412 and/or the status LED(s) 414 of the server tray(s) 402. In some embodiments, the robotic mechanism(s) 304 may perform the action(s) 312 with respect to the fans(s) 422 and/or the status LED(s) 424 of the power supply 408.

In some embodiments, the power supply 408 is configured to provide DC electrical power to the server tray(s) 402 and/or one or more other server trays mounted within the server rack 401. For example, the power supply 408 may be housed in a top frame and/or another location within the server rack 401 such that a power distribution channel of the server rack 401 is supplied with an appropriate current or voltage differential for powering the server tray(s) 402 and/or one or more other server trays mounted within the server rack 401. In various embodiments, the power supply 408 is in compliance with the ORV3 standards. In some embodiments, the robotic mechanism(s) 304 may perform the action(s) 312 with respect to the power supply 408 to determine whether the power supply 408 is supplying appropriate current or voltage differential for powering the server tray(s) 402 and/or one or more other server trays mounted within the server rack 401.

In some embodiments, the server rack 401 includes a pluggable liquid cooling connector configured to enable the server tray(s) 402 to selectively be placed into fluid communication with a liquid cooling manifold of the server rack 401. For example, the pluggable liquid cooling connector may be configured such that, at a tray location for the server tray(s) 402, the server tray(s) 402 may be mounted such that the server tray(s) 402 may be fluidly coupled to the pluggable liquid cooling connector(s) corresponding to the tray location. In some embodiments, the robotic mechanism(s) 304 may perform the action(s) 312 with respect to the server tray(s) 402 to determine whether the liquid cooling connector is leaking fluid.

FIG. 5 provides an external view of the server tray(s) 402 and shows a switch tray having a plurality of connector ports on a front panel of the tray. However, it should be understood that analogous features and methods may be implemented for compute trays comprising a plurality of processing resources. As illustrated in FIG. 5, the server tray(s) 402 includes a set of cable connector ports 502 at a front panel 504 of the server tray(s) 402. For example, the set of cable connector ports 502 may include data connector ports, networking ports, USB ports, and/or one more other types of ports to enable cabling with respect to the server tray(s) 402. In some embodiments, the set of cable connector ports 502 include a set of ports for one or more network adaptors. In some embodiments, the set of cable connector ports 502 include a set of ports for one or more Network Interface Controllers (NICs). In some embodiments, the set of cable connector ports 502 include a set of ports for Quad Small Form-factor Pluggable (QSFP) cable connectors. As discussed herein, the illustrated server tray(s) 402 is a switch tray, however compute trays comprising a plurality of processing resources may have analogous structural components of a housing and front panel that may operate in a similar manner for other server tray configurations. In some embodiments, the robotic mechanism(s) 304 may perform the action(s) 312 with respect to the set of cable connector ports 502 of the server tray(s) 402. For example, the robotic mechanism(s) 304 may connect one or more cables and/or cable connectors at the set of cable connector ports 502 via the action(s) 312.

Datacenters are the storage and data processing hubs of the internet. The massive deployment of cloud applications is causing datacenters to expand exponentially in size, stimulating the development of faster switches than may cope with the increasing data traffic inside the datacenter. Current state-of-the-art switches are capable of handling 12.8 Tb/s of traffic by employing electrical switches in the form of application specific integrated circuits (ASICs) equipped with 256 data lanes, each operating at 50 Gbps. Such switching ASICs typically consume as much as 400 W, and the power consumption of the optical transceiver interfaces attached to each ASIC is comparable. To keep pace with traffic demand, switch capacity doubles approximately every two years. To date, this rapid scaling has been made possible by exploiting advances in manufacturing (e.g., CMOS techniques), collectively described by Moore's law (i.e., the observation that the number of transistors in a dense integrated circuit doubles about every two years). However, in recent years there are strong indications of Moore's law slowing down, which raises concerns about the capability to sustain the target scaling rate of switch capacity. As a result, in various embodiments, the AI model(s) and/or the robotic system 302 may be utilized to enable the datacenter system 110 to scale at a desirable rate to satisfy increased data traffic demands for the datacenter system 110.

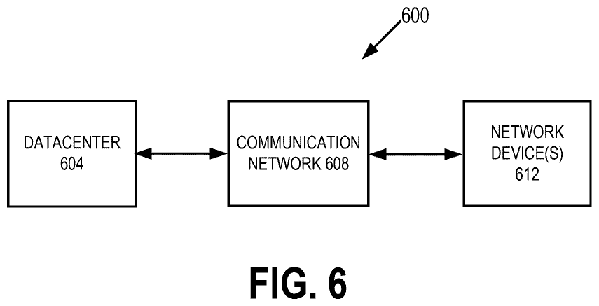

FIG. 6 provides a system 600 according to at least one example embodiment. The system 600 includes a datacenter 604, a communication network 608, and one or more network devices 612. In various embodiments, the datacenter 604 corresponds to at least a portion of the datacenter system 110. In at least one example embodiment, the datacenter 604 corresponds to a collection of network devices, such as network switches (e.g., Ethernet switches) connected with a collection of servers or compute nodes. The datacenter 604 may adhere to a networking topology (e.g., a hierarchal networking topology), such as a fat tree topology, a Slim Fly topology, a Dragonfly topology, and/or the like. The datacenter 604 routes traffic amongst the network switches and servers therein, and at least one layer of the topology in the datacenter 604 is coupled to the communication network 608 to allow networking traffic to flow between the datacenter 604 and the network device(s) 612.

Examples of the communication network 608 that may be used to connect the datacenter 604 and the network device(s) 612 include an Internet Protocol (IP) network, an Ethernet network, an InfiniBand (TB) network, a Fibre Channel network, the Internet, a cellular communication network, a wireless communication network, combinations thereof (e.g., Fibre Channel over Ethernet), variants thereof, and/or the like.

The one or more network devices 612 may include switch, router, or Network Interface Controller (NIC), interconnect using ports, one or more of Personal Computer (PC), a laptop, a tablet, a smartphone, a server, a collection of servers, and/or any suitable computing device for sending and receiving signals over the communication network 608. In at least one example embodiment, the one or more network devices 612 correspond to another datacenter, similar to or the same as datacenter 604.

As noted above, the datacenter 604 and/or the network device(s) 612 may include storage devices and/or processing circuitry for carrying out computing tasks, for example, tasks associated with controlling the flow of data internally and/or over the communication network 608. Such processing circuitry may comprise software, hardware, or a combination thereof. For example, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory).

Additionally or alternatively, the processing circuitry may comprise hardware, such as an application specific integrated circuit (ASIC). For example, the processor may be or include one or more of an Integrated Circuit (IC) chip, a microprocessor, a CPU, a GPU, a DPU, a QPU, PPUs, a Field Programmable Gate Array (FPGA), a network interface controller (NIC), an ASIC, combinations thereof, and the like. The processing circuitry may comprise an ASIC and/or may be capable of performing as a CPU, a GPU, a network interface controller (NIC), a data processing unit (DPU), or any other computing device in which with data is received and/or transmitted. QPUs configured to perform one or more operations associated with a quantum algorithm In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

Some or all of the processing circuitry may be provided on a Printed Circuit Board (PCB) or collection of PCBs. It should be appreciated that any appropriate type of electrical component or collection of electrical components may be suitable for inclusion in the processing circuitry.

In addition, although not explicitly shown, it should be appreciated that the datacenter 604 and network device(s) 612 may include one or more communication interfaces for facilitating wired and/or wireless communication between one another and other unillustrated elements of the system 600.

In related art systems, a fat tree topology may use the same electrical switching devices on all layers (edge, aggregation, core). For example, each switching device may be 1 U switch, where 1 U refers to the industry standard size for rack-mounted switch and/or server. The interconnection between switches of different layers may be accomplished with optical links or optical interconnects using active optical cables and optical transceivers implemented in a pluggable form factor (also referred to as “pluggables”).

Optical Datacenter Networks rely on allocation and deallocation of light paths from the data sources to the destinations end-ports to guarantee no light collisions and data loss occur in the fabric. Traditionally the allocation algorithms are run from a central entity which considers the entire demand for source and destination flows and try to find the most dense mapping of these demands to network resources over a single or multiple time periods.

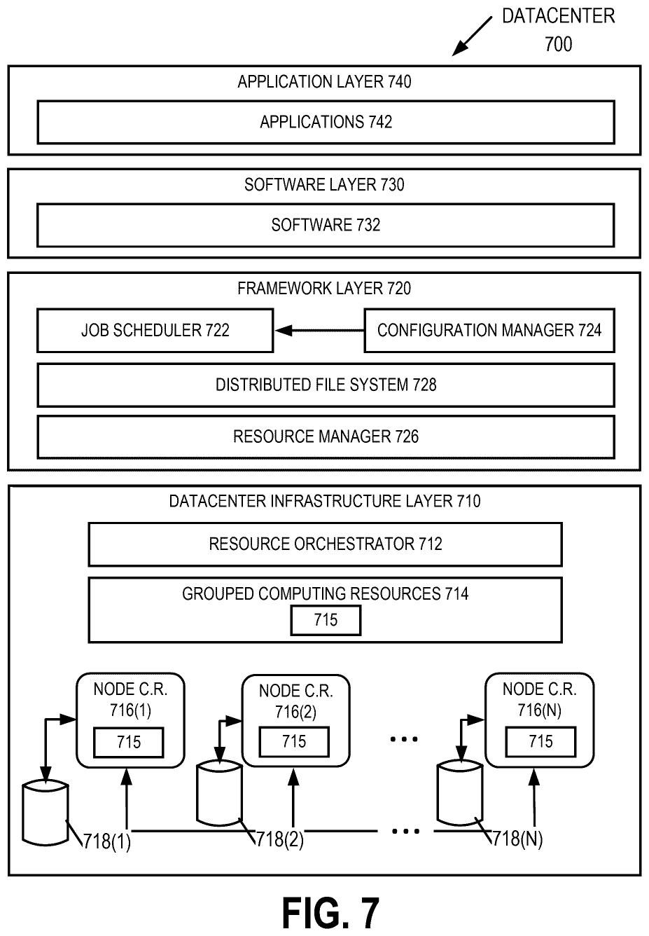

FIG. 7 provides an example datacenter 700, in which at least one embodiment may be used. In at least one embodiment, datacenter 700 includes a datacenter infrastructure layer 711, a framework layer 720, a software layer 730, and an application layer 740. In various embodiments, the datacenter 700 corresponds to at least a portion of the datacenter system 110.

In at least one embodiment, as shown in FIG. 7, datacenter infrastructure layer 711 may include a resource orchestrator 712, grouped computing resources 714, and node computing resources (“node C.R.s”) 716(1)-716(N), where “N” represents a positive integer (which may be a different integer “N” than used in other figures). In at least one embodiment, node C.R.s 716(1)-716(N) may include, but are not limited to, any number of central processing units (“CPUs”) or other processors (including accelerators, field programmable gate arrays (FPGAs), graphics processors, etc.), memory storage devices 718(1)-718(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R. s from among node C.R.s 716(1)-716(N) may be a server comprising one or more of above-mentioned computing resources.

In at least one embodiment, grouped computing resources 714 may include separate groupings of node C.R.s housed within one or more racks (not shown), or many racks housed in datacenters at various geographical locations (also not shown). In at least one embodiment, separate groupings of node C.R.s within grouped computing resources 714 may include grouped compute, network, memory, or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for datacenter 700. In at least one embodiment, resource orchestrator 712 may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 728 for large-scale data processing (e.g., “big data”). In at least one embodiment, job scheduler 722 may include a Spark driver to facilitate scheduling of workloads supported by various layers of datacenter 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resources 714 at datacenter infrastructure layer 711. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. In at least one embodiment, one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a datacenter operator of datacenter 700 from making possibly bad configuration decisions and possibly avoiding underutilized and/or poor performing portions of a datacenter.

In at least one embodiment, datacenter 700 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 700. In at least one embodiment, trained machine learning models corresponding to one or more neural networks may be used to infer or predict information using resources described above with respect to datacenter 700 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein.

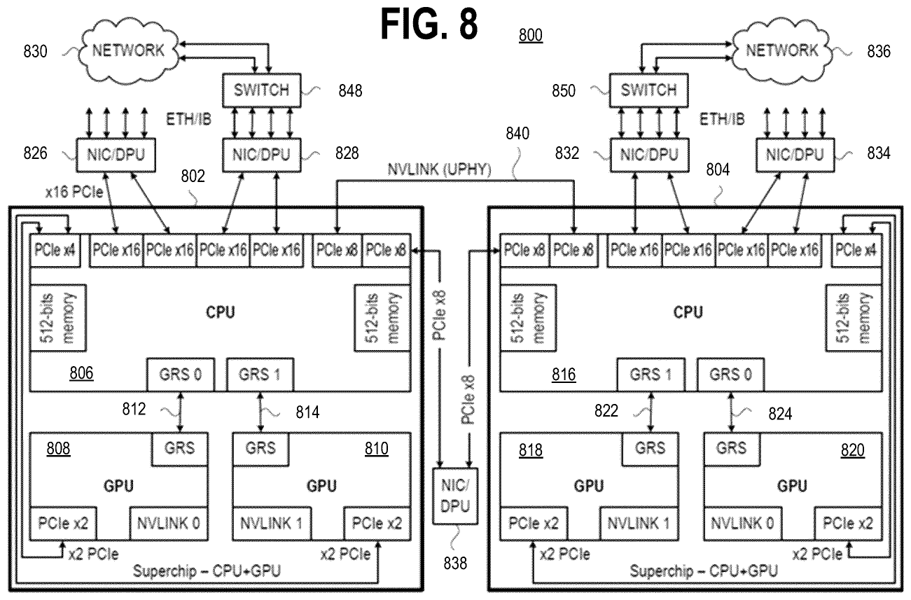

FIG. 8 is a block diagram that schematically illustrates a computing system 800, e.g., a datacenter or a High-Performance Computing (HPC) cluster, in accordance with an embodiment that is described herein. Computing system 800 comprises a plurality of subsystems, e.g. multiple processing devices coupled to each other, multiple network devices, and multiple networks, according to at least one embodiment. Computing system 800 is designed with multiple integrated circuits (referred to as processing devices), where each integrated circuit may include one or more CPUs and GPUs, forming a powerful and flexible architecture. In various embodiments, the computing system 800 corresponds to at least a portion of the datacenter system 110.

The various processing devices are interconnected via an NVLink or other high-speed interconnect, enabling high-speed communication between the subsystems, and are also connected through a NIC or DPU to ensure efficient data transfer across computing system 800 and to one or more external networks 830, 836. In the present example, computing system 800 comprises a packet switch 848 that connects NIC/DPU 828 to network 830, and a packet switch 850 that connects NIC/DPU 832 to network 836.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 800 may include one or more CPUs and one or more GPUs.

FIG. 8 also demonstrates an example architecture of a multi-GPU architecture. As illustrated in the figure, computing system 800 includes a processing device 802 with a multi-GPU architecture. In particular, processing device 802 may be a system-on-chip and includes multiple subsystems such as a CPU 806, a GPU 808, and a GPU 810. CPU 806 may be coupled to GPU 808 via a die-to-die (D2D) or chip-to-chip (C2C) interconnect 812, such as a Ground-Referenced Signaling interconnect (GRS interconnect). CPU 806 may be coupled to GPU 810 via a D2D or C2C interconnect 814. CPU 806 may also couple to GPU 808 and GPU 810 via PCIe interconnects.

CPU 806 may be coupled to one or more NICs or DPUs, which are coupled to one or more networks. For example, as illustrated in FIG. 8, CPU 806 is coupled to a first NIC/DPU 826, which is coupled to a network 830. CPU 806 is also coupled to a second NIC/DPU 828, which is coupled to network 830 via packet switch 848. NIC/DPU 826 and NIC/DPU 828 may be coupled to network 830 over Ethernet (ETH), NVLINK or InfiniBand (IB) connections, for example.

Computing system 800 also includes a processing device 804 with a multi-GPU architecture. In particular, processing device 804 includes multiple subsystems including a CPU 816, a GPU 818, and a GPU 820. CPU 816 may be coupled to GPU 818 via an D2D or C2C interconnect 822. CPU 816 may be coupled to GPU 820 via a D2D or C2C interconnect 824. CPU 816 may also couple to GPU 818 and GPU 820 via PCIe interconnects. CPU 816 may be coupled to one or more NICs or DPUs, which are coupled to one or more networks. For example, as illustrated in FIG. 8, CPU 816 is coupled to a first NIC/DPU 832, which is coupled to a network 836. CPU 816 is also coupled to a second NIC/DPU 834, which is coupled to network 836 via switch 850. NIC/DPU 832 and NIC/DPU 834 may be coupled to network 836 over Ethernet (ETH), NVLINK or InfiniBand (IB) connections.

In at least one embodiment, processing device 802 and processing device 804 may communication with each other via a NIC/DPU 838, such as over PCIe interconnects. Processing device 802 and processing device 804 may also communicate with each other over a high-bandwidth communication interconnects 840, such as an NVLink interconnect or other high-speed interconnects. The packet switches in FIG. 8 may comprise, for example, Nvidia Quantum-2 switches. The NICs/DPUs in the figure may comprise, for example, Nvidia Bluefield DPUs.

In various embodiments, one or more of the interconnects 812, 814, 822, 824 may be optical interconnects disclosed herein. Additionally, in various embodiments, packet switches 848, 850 may be in communication with NIC/DPU 828, 832, respectively, via one or more optical interconnects disclosed herein. In some embodiments, NIC/DPU 826, 834 may be in communication with one or more additional elements via optical interconnects disclosed herein. For example, various elements of the computing system 800 may be in communication with one another via one or more optical interconnects disclosed herein.

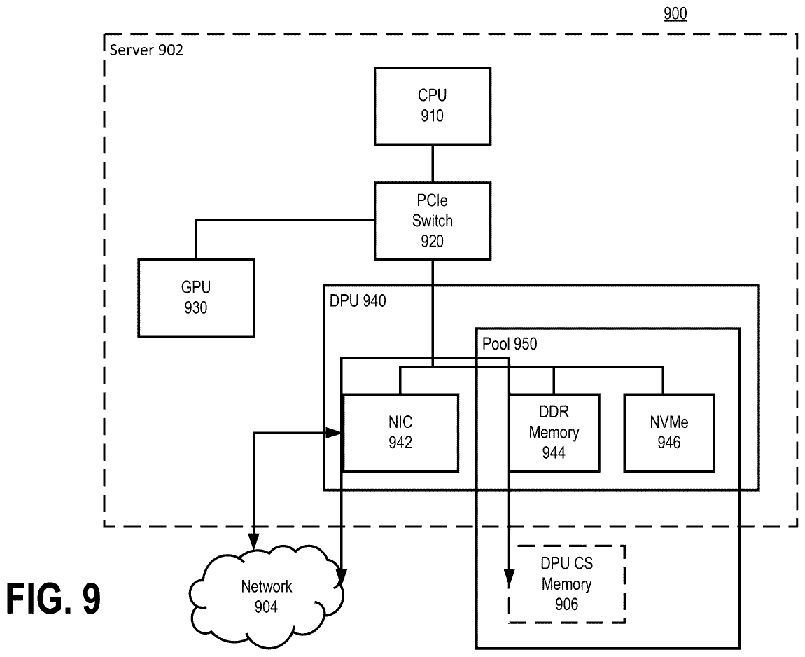

FIG. 9 illustrates an example computing environment 900 in which forward pass offloading to available memory may be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 900 may include a server 902 which may be used to perform high performance computing (HPC) workloads, such as AI training or machine learning model training. In an embodiment, the server 902 may be an application instance or a compute node. The server 902 may include a CPU 910 associated with a switch 920, such as a peripheral component interconnect express (PCIe) switch, which may control at least some data transmission over communication paths interconnecting various components. In an embodiment, the CPU 910 may include a root complex processor. In various embodiments, the computing environment 900 corresponds to at least a portion of the datacenter system 110.

The PCIe switch 920 may also be associated with a GPU 930 and a DPU 940, and may transmit data between at least some of the CPU 910, the GPU 930, the DPU 940, and other components (e.g., via one or more optical interconnects disclosed herein). In an embodiment, the PCIe switch 920 may be associated with more than one GPU or more than one DPU. In another embodiment, the PCIe switch 920 may be located within the DPU 940. The PCIe switch 920 may manage the transfer of at least some data between the CPU 910, the GPU 930, and the DPU 940. In another embodiment, the number of GPUs associated with the PCIe switch 920 may be equal to the number of DPUs associated with the PCIe switch 920. In at least one embodiment, the server 902 may include, without limitation, any number of the CPUs 910, the PCIe switches 920, the GPUs 930, and/or the DPUs 940, in any combination. For example, in at least one embodiment, server 902 could include eight, sixteen, thirty-two, and/or more GPUs 930. In at least one embodiment, communication paths interconnecting various components, including but not limited to the CPU 910, the PCIe switch 920, the GPU 930, and the DPU 940, in FIG. 9 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 940 may include a network interface controller (NIC) 942, a DDR memory 944, and a non-volatile memory express (NVMe) device 946. The NIC 942 may be able to interface with a network 904, which may also interface with additional NVMe devices available to the DPU 940, such as over fabric. In an embodiment, the DPU 940 may not include the NVMe device 946. In another embodiment, the NVMe device 946 may be located on the server 902 and not on the DPU 940. In yet another embodiment, the computing environment 900 may include more than one of the NVMe device 946, such as a first NVMe device in the DPU 940 and a second first NVMe device on the server 902 an associated directly with the PCIe switch 920. In an embodiment, the DPU 940 may not include the DDR memory 944 and may include a computational storage services (CSS) in place of, or in addition to, the DDR memory 944. For example, computing environment 900 may include DPU computational storage (CS) memory 906 available to the DPU 940 as part of the CSS. The network 904 may be able to interface with the DPU CS memory 906 through the NIC 942, according to any suitable interface protocol, such as remote direct memory access (RDMA) over Ethernet, InfiniBand, Fiber Channel, etc.

The total memory of the computing environment 900 available for data storage may be expanded through the use of the DPU 940 on nodes of the system. The DPU 940 may have access to a pool 950 of memory already available to the server 902, such as double data rate (DDR) memory, on-board NVMe devices, NVMe devices over fabric, and CS. The pool 950 of memory may include at least one of the DDR memory 944, NVMe 946, and the DPU CS memory 906. The DPU 940 may also be able to access the available memory of other DPUs as part of the pool 950, and other DPUs may be able to access the available memory of DPU 940, such as the pool 950. This available memory may be accessed and utilized for data storage, without the addition of compute resources, such as compute nodes, which would be required using other solutions. The available pool 950 accessible to the DPU 940 may be provisioned for the server 902 to expand the total memory available for data storage, such as to reduce the data storage load on the CPU 910 or the GPU 930, which may instead increase the utilization of their memory for processing. For example, during training of an AI, the model states, residual states, activation functions, and checkpoints may be stored, or offloaded, on the pool 950 accessible to the DPU 940.

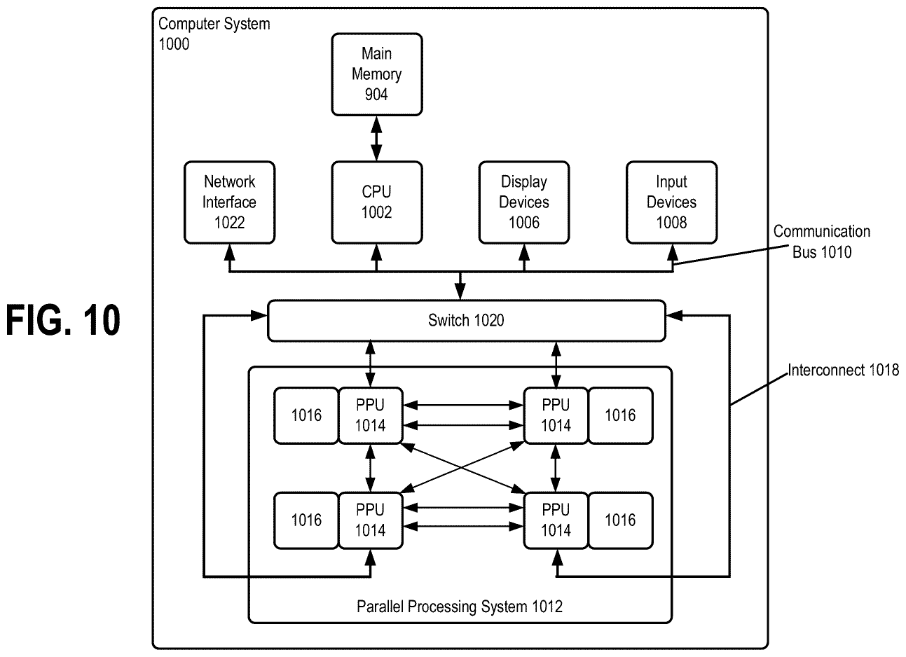

FIG. 10 illustrates a computer system 1000, according to at least one embodiment. In at least one embodiment, computer system 1000 comprises at least one optical interconnect of an example embodiment. In various embodiments, the computer system 1000 corresponds at least a portion of to the datacenter system 110.

In at least one embodiment, computer system 1000 comprises, without limitation, at least one central processing unit (“CPU”) 1002 that is connected to a communication bus 1010 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1000 includes, without limitation, a main memory 1004 and control logic (e.g., implemented as hardware, software, or a combination thereof) and data are stored in main memory 1004 which may take form of random access memory (“RAM”). In at least one embodiment, a network interface subsystem (“network interface”) 1022 provides an interface to other computing devices and networks for receiving data from and transmitting data to other systems from computer system 1000.

In at least one embodiment, computer system 1000, in at least one embodiment, includes, without limitation, input devices 1008, parallel processing system 1012, and display devices 1006 which may be implemented using a conventional cathode ray tube (“CRT”), liquid crystal display (“LCD”), light emitting diode (“LED”), plasma display, or other suitable display technologies. In at least one embodiment, user input is received from input devices 1008 such as keyboard, mouse, touchpad, microphone, and more. In at least one embodiment, each of foregoing modules may be situated on a single semiconductor platform to form a processing system.

In at least one embodiment, computer programs in form of machine-readable executable code or computer control logic algorithms are stored in main memory 1004 and/or secondary storage. Computer programs, if executed by one or more processors, enable system 1000 to perform various functions in accordance with at least one embodiment. memory 1004, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 1002; parallel processing system 1012; an integrated circuit capable of at least a portion of capabilities of both CPU 1002; parallel processing system 1012; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 1000 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 1012 includes, without limitation, a plurality of parallel processing units (“PPUs”) 1014 and associated memories 1016. In at least one embodiment, PPUs 1014 are connected to a host processor or other peripheral devices via an interconnect 1018 and a switch 1020 or multiplexer. In at least one embodiment, parallel processing system 1012 distributes computational tasks across PPUs 1014 which may be parallelizable—for example, as part of distribution of computational tasks across multiple graphics processing unit (“GPU”) thread blocks. In at least one embodiment, memory is shared and accessible (e.g., for read and/or write access) across some or all of PPUs 1014, although such shared memory may incur performance penalties relative to use of local memory and registers resident to a PPU 1014. In at least one embodiment, operation of PPUs 1014 is synchronized through use of a command such as syncthreads( ), wherein all threads in a block (e.g., executed across multiple PPUs 1014) to reach a certain point of execution of code before proceeding.

The PPUs 1014 may be in communication with one another and/or switch 1020 via one or more optical interconnects in accordance with example embodiments disclosed herein.

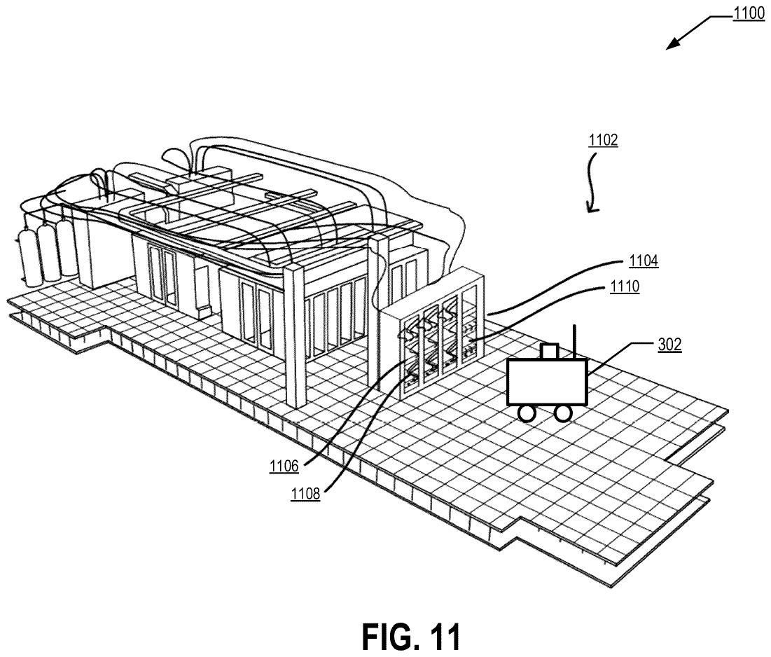

FIG. 11 illustrates a datacenter 1100, according to at least one embodiment. In various embodiments, the datacenter 1100 corresponds at least a portion of the datacenter system 110. In at least one embodiment, a computing environment may include a variety of computing devices and control systems, as illustrated in datacenter 1100 FIG. 11. In at least one embodiment, datacenter 1100 may include one or more rooms 1102 having racks 1104 and auxiliary equipment used to house one or more servers on one or more server trays. In at least one embodiment, datacenter 1100 is supported by various cooling systems, such as cooling towers, cooling loops, pumps, and other support systems. In at least one embodiment, servers 1106 are positioned within racks 1104. In at least one embodiment, servers 1106 within racks 1104 receive operational power from a source and may also be coupled to various communication sources, such as a connection to a network line. In at least one embodiment, electrical cables 1108 are extended to racks 1104 to couple to individual servers 1106. In at least one embodiment, electrical cables 1108 are routed through compartments built into racks 1104 to a backside where various connections are made. In at least one embodiment, connections may extend between components within racks 1104, such as from power distribution units to servers 1106, as well as between different servers 1106. In at least one embodiment, identifying starting and ending locations for electrical cables 1108 may be challenging due to a large number of cables associated with each server 1106 within racks 1104.

In at least one embodiment, servers 1106 are swapped out of racks 1104 for maintenance, updates, and other operations. In at least one embodiment, servers 1106 may be frequently replaced for validation and manufacturing test flow situations, among other operations. In at least one embodiment, operations personnel (or mobile robots) remove connections to servers 1106 prior to removal and either reroute electrical cables 1108 or identify a storage location for electrical cables 1108. In at least one embodiment, newly added servers 1106 use different connections than previously used servers 1106, leading to additional electrical cable routing. In at least one embodiment, electrical cables connected to each server 1106 are numerous, which may restrict air flow and provide an unorganized appearance.

In at least one embodiment, electrical cables 1108 are routed from various locations and may cover long distances across data centers prior to reaching a specified rack 1104. In at least one embodiment, it is desirable to reduce rerouting of cables during maintenance or server change out operations to reduce overall time and complexity with operations. In at least one embodiment, an interface panel 1110 may be provided to reduce rerouting of cables and other connections during operations. In at least one embodiment, interface panels 1110 are positioned within racks 1104 near associated servers 1106. In at least one embodiment, interface panels 1110 include receptacles and other connection ports that correspond, or substantially correspond, to associated receptacles and connection ports for one or more servers 1106. In at least one embodiment, interface panels 1110 receive an initial input connection that is routed to servers 1106 via internal writing of interface panels 1110. In at least one embodiment, interface panels 1110 may be arranged within racks 1104, for example between racks 1104 including servers 1106, or within racks 1104 that also house servers 1106. In at least one embodiment, interface panels 1110 include receptacles that receive connections from servers 1106 and various other components to provide operational power or form data connections.

In at least one embodiment, interface panels 1110 occupy rack space corresponding to a height of interface panels 1110. In at least one embodiment, interface panels 1110 are arranged next to racks 1104 including servers 1106 to supply power or form data connections to a particular number of servers 1106 within racks 1104. In at least one embodiment, interface panels 1110 with greater numbers of receptacles or data interfaces may provide power or data communication to more servers 1106 or various other components. In at least one embodiment, associated computing or datacenter devices include GPUs, in switches, in dual inline memory module (DIMMs), or CPUs. In at least one embodiment, an associated computing or datacenter device may include a processing card having one or more GPUs, switches, or CPUs thereon. In at least one embodiment, each of these GPUs, switches, and CPUs may be a heat generating or power consuming feature of this computing device. In at least one embodiment, this GPU, CPU, or switch may have one or more cores.

In some embodiments, the datacenter 1100 includes the robotic system 302. The robotic system 302 may be a mobile robot that is configured to traverse an interior environment of the datacenter 1100. For example, the robotic system 302 may be configured to traverse the one or more rooms 1102 of the datacenter 1100. In some embodiments, the robotic mechanism(s) 304 of the robotic system 302 may enable the action(s) 312 to be performed with respect to the datacenter 1100. For example, the robotic mechanism(s) 304 of the robotic system 302 may enable the action(s) 312 to be performed with respect to the racks 1104, servers 1106, electrical cables 1108, and/or the interface panels 1110 of the datacenter 1100. In some embodiments, those actions may comprise removing, reconnecting, reorganizing or rerouting cables connected at the servers 1106 and/or interface panels 1110. In other embodiments, those actions may comprise removing one or more servers 1106 and/or interface panels 1110. In yet other embodiments, those actions may comprise removing debris from one or more servers 1106, racks 1105, and/or interface panels 1110. Those actions may be performed by the robotic mechanisms as discussed herein. In some embodiments, the server rack 401 may correspond to one of the racks 1104 and/or the server tray(s) 402 may correspond to at least one of the servers 1106. In some embodiments, one or more of the electrical cables 1108 may be connected to the set of cable connector ports 502.

### Performance Optimization Method for a Datacenter

Having described example systems in accordance with the present disclosure, example processes of the present disclosure will now be discussed. It will be appreciated that each of the flowcharts depicts an example computer-implemented process that is performable by one or more apparatuses, systems, circuits, devices, and/or computer program products described herein, for example utilizing one or more of the specially configured components thereof.

Although the example processes depict a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

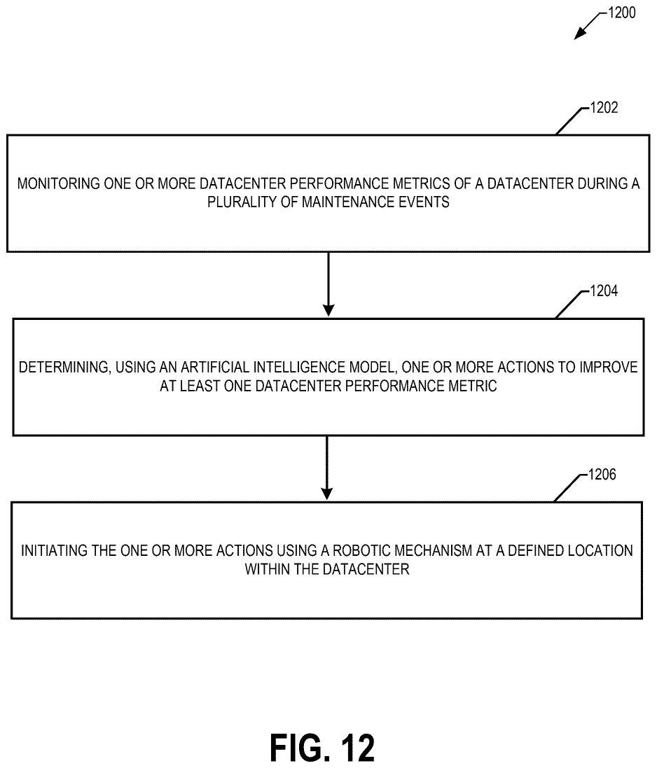

FIG. 12 illustrates a process 1200 depicting example operations for providing performance optimization for a datacenter via a robotic system in accordance with one or more embodiments of the present disclosure. The process may embody an example computer-implemented method. In some embodiments, the process 1200 is embodied by computer program code stored on a non-transitory computer-readable storage medium of a computer program product configured for execution to perform the process as depicted and described. Alternatively or additionally, in some embodiments, the process is performed by one or more specially configured computing devices, such as the performance optimization apparatus 102 alone or in communication with one or more other component(s), device(s), system(s), and/or the like. In this regard, in some embodiments, the performance optimization apparatus 102 is specially configured by computer-coded instructions (e.g., computer program instructions) stored thereon, for example in memory and/or another component depicted and/or described herein and/or otherwise accessible to the performance optimization apparatus 102, for performing the operations as depicted and described. In some embodiments, the performance optimization apparatus 102 is in communication with one or more external apparatus(es), system(s), device(s), and/or the like, to perform one or more of the operations as depicted and described. For example, the performance optimization apparatus 102 in some embodiments is in communication with and/or incorporated as part of the server tray(s) 402. For purposes of simplifying the description, the process 1200 is described as performed by and from the perspective of the performance optimization apparatus 102.

In some embodiments, the process 1200 includes monitoring one or more datacenter performance metrics of a datacenter during a plurality of maintenance events, as shown at block 1202. In some embodiments, the process 1200 includes determining, using an artificial intelligence model, one or more actions to improve at least one datacenter performance metric, as shown at block 1204. In some embodiments, the process 1200 includes initiating the one or more actions using a robotic mechanism at a defined location within the datacenter, as shown at block 1206.

Although an example processing system has been described above, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer storage medium for execution by, or to control the operation of, information/data processing apparatus. Alternatively, or in addition, the program instructions may be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium may also be, or be included in, one or more separate physical components or media (e.g., multiple CDs, disks, or other storage devices).

The operations described herein may be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (application-specific integrated circuit). The apparatus may also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment may realize various different computing model infrastructures, such as web services, distributed computing and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described herein may be implemented on a computer comprising a display device, e.g., a CRT (cathode ray tube) or LCD (liquid crystal display) monitor, for displaying information/data to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Embodiments of the subject matter described herein may be implemented in a computing system that includes a back-end component, e.g., as an information/data server, or that includes a middleware component, e.g., an application server, or that includes a front-end component, e.g., a client computer comprising a graphical user interface or a web browser through which a user may interact with an implementation of the subject matter described herein, or any combination of one or more such back-end, middleware, or front-end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and comprising a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) may be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for optimizing performance of a datacenter, the method comprising:
monitoring one or more datacenter performance metrics of a datacenter during a plurality of maintenance events using an artificial intelligence model;
determining, using the artificial intelligence model, one or more actions to improve at least one datacenter performance metric; and
initiating the one or more actions using a robotic mechanism at a defined location within the datacenter.

2. The method of claim 1, wherein initiating the one or more actions using a robotic mechanism comprises causing a mobile robot to move to the defined location within the datacenter.

3. The method of claim 1, wherein initiating the one or more actions using a robotic mechanism comprises causing the robotic mechanism to perform the one or more actions with respect to an interior datacenter environment of the datacenter.

4. The method of claim 1, wherein initiating the one or more actions using a robotic mechanism comprises causing the robotic mechanism to perform the one or more actions with respect to a server rack of the datacenter.

5. The method of claim 1, wherein initiating the one or more actions using a robotic mechanism comprises causing the robotic mechanism to connect one or more cables at one or more server racks within the datacenter.

6. The method of claim 1, wherein monitoring the one or more datacenter performance metrics of the datacenter comprises capturing sensor data associated with an interior datacenter environment of the datacenter via a mobile robot.

7. The method of claim 1, wherein monitoring the one or more datacenter performance metrics of the datacenter comprises capturing sensor data associated with a server rack of the datacenter via a mobile robot.

8. The method of claim 1, wherein the artificial intelligence model executes at least partially in the datacenter.

9. The method of claim 1, further comprising:
monitoring the at least one datacenter performance metric subsequent to initiating the one or more actions using the robotic mechanism; and
determining, using the artificial intelligence model, an action for the robotic mechanism to further improve the at least one datacenter performance metric.

10. A robotic system comprising:
a mobile robot configured to perform one or more robotic-based actions; and
one or more computing devices configured to:
monitor one or more datacenter performance metrics of a datacenter during a plurality of maintenance events using an artificial intelligence model;
determine, using the artificial intelligence model, one or more actions to improve at least one datacenter performance metric;
initiate performance of the one or more actions using the mobile robot.

11. The robotic system of claim 10, the one or more computing devices further configured to:
cause the mobile robot to move to the defined location within the datacenter.

12. The robotic system of claim 10, the one or more computing devices further configured to:
cause the mobile robot to perform the one or more actions with respect to an interior datacenter environment of the datacenter.

13. The robotic system of claim 10, the one or more computing devices further configured to:
cause the mobile robot to perform the one or more actions with respect to a server rack of the datacenter.

14. The robotic system of claim 10, the one or more computing devices further configured to:
cause the mobile robot to connect one or more cables at one or more server racks within the datacenter.

15. The robotic system of claim 10, wherein the mobile robot is configured to capture sensor data associated with an interior datacenter environment of the datacenter during the plurality of maintenance events.

16. The robotic system of claim 10, wherein the mobile robot is configured to capture sensor data associated with a server rack of the datacenter during the plurality of maintenance events.

17. The robotic system of claim 10, wherein the artificial intelligence model executes at least partially in the datacenter.

18. One or more non-transitory computer-readable storage media storing instructions that, when executed by one or more processors, cause the one or more processors to:
monitor one or more datacenter performance metrics of a datacenter during a plurality of maintenance events using an artificial intelligence model;
determine, using the artificial intelligence model, one or more actions to improve at least one datacenter performance metric; and
initiate the one or more actions using a robotic mechanism at a defined location within the datacenter.

19. The one or more non-transitory computer-readable storage media of claim 18, wherein the instructions further cause the one or more processors to:
cause a mobile robot to move to the defined location within the datacenter.

20. The one or more non-transitory computer-readable storage media of claim 18, wherein the instructions further cause the one or more processors to:
cause the robotic mechanism to perform the one or more actions with respect to a server rack of the datacenter.
